(19) United States
(12) Patent Application Publication
(10) Pub. No.: US 2014/0170358 A1
(43) Pub. Date: Jun. 19, 2014

(54) Double-Sided Reusable Adhesive Sheet

(71) Applicants: Chi Yuan Chang, New Taipei City (TW); Lechie Lin, Taipei City (TW)

(72) Inventors: Chi Yuan Chang, New Taipei City (TW); Lechie Lin, Taipei City (TW)

(21) Appl. No.: 14/085,809

(22) Filed: Nov. 21, 2013

(30) Foreign Application Priority Data
Dec. 13, 2012 (TW) 101224100

(51) Int. Cl. C09J 7/02

(52) U.S. Cl. CPC C09J 7/02
USPC 428/40.9; 428/40.1; 428/41.8; 428/41.3

(57) ABSTRACT

A double-sided reusable adhesive sheet which includes a substrate, a first film layer attached to one surface of the substrate, and a second film layer attached to an opposed surface of the substrate, wherein a glass transition temperature of a high temperature curing process of the first and second film layers is 120˜240° C., wherein surfaces of said first and second film layers are respectively provided with a plurality of micro-bubble structures, so that the first and second film layers can be repeatedly engaged and disgengaged and the adhering force is also enhanced, so that a reusable adhesive double-sided sheet structure is provided.

### NOTICE OF COPYRIGHT

A portion of the disclosure of this patent document contains material which is subject to copyright protection. The copyright owner has no objection to any reproduction by anyone of the patent disclosure as it appears in the United States Patent and Trademark Office patent files or records, but otherwise reserves all copyright rights whatsoever.

### BACKGROUND OF THE PRESENT INVENTION

1. Field of Invention

The present invention relates to a double-sided sheet structure, and more particularly to a double-sided sheet structure which is reusable for adhesion.

2. Description of Related Arts

A conventional double-sided reusable adhesive sheet structure, which can be generally used on various surfaces (such as wall surfaces, tile surfaces, and glass surfaces), is arranged for providing an adhesive decoration pattern or used for connecting a variety of hanging articles. No matter what common home uses or various business uses of the adhesive glues, adhesive glues in various forms have been used for adhesion purposes. Currently, many different types of products which contain adhesive glues are accessible in the market, such as common adhesive tapes, double-sided adhesive tapes, easily tearable adhesive tapes, and inertia glues which are produced by 3M corporation. However, the glue agents of most adhesive tapes have a common problem that they cannot be repeatedly used for adhesion. In other words, residual adhesive glues may stay on the adhering surface; or once the adhesive tape has been used, the adhesive glues will lose their adhering ability sharply and cannot be recovered for reuse. Besides the clearing problem and the issue of aesthetic appearance, the areas suitable for using adhesive tapes with the adhesive glues are also greatly limited.

U.S. patent publication 20070020474 discloses a double-sided adhesive thin film which includes a supporting film, a first adhesive agent layer formed on one surface of the supporting film, and a second adhesive agent layer formed on the other surface of the supporting film. The glass transition temperature after the curing process of the first adhesive agent layer and the second adhesive agent layer is less than or equal to 100° C. Therefore, the first adhesive agent layer and the second adhesive agent layer are in glue form, so that they are not easily removed after being used for adhesion, and also they cannot be reused. Another drawback is that the adhesive layers are in glue form and the glass transition temperature of the adhesive layers should be less than or equal to 100° C. In other words, when the temperature is above 100° C., the adhesive layers will be transformed from the glue form into the curing form so that there will be no adhering ability for the adhesive layers .

Taiwan patent publication 201105765 discloses a re-tearable adhesive material which includes a substrate layer and at least two adhesive layers. An interior tearable interface is provided between one surface of the substrate layer and the adhesive layer, the peeling strength at the interior tearable interface is different from the peeling strength between the adhesive layer and the object to be adhered. Therefore, although the re-tearable adhesive material is provided with double-sided adhesive layers and also can be reused, since the peeling strength of the adhering interface is different, when the object to be adhered has to withstand a load (such as a hanging hook), the adhesive material may slip off due to its inability to adhere because of the weight the load. Therefore, there is still a demand for developing and modifying the double-sided reusable adhesive structure.

In view of the above drawbacks, the inventors herein, who have many years experience in this field, have devoted much effort to overcome the aforesaid drawbacks and finally develop a novel type of double-sided reusable adhesive sheet. By means of a simple design, the present invention is capable of providing a stable adhering performance and is also reusable.

### SUMMARY OF THE PRESENT INVENTION

The main object of the present invention is to provide a double-sided reusable adhesive sheet, wherein the double-sided reusable adhesive sheet comprises a first film layer and a second film layer, wherein the surfaces of the first and second film layers are respectively provided with a plurality of micro-bubble structures, so that the first and second film layers are reusable for adhesion.

Another object of the present invention is to provide a double-sided reusable adhesive sheet, wherein the glass transition temperature after the high temperature curing process of the first and second film layers is 120˜240° C., so that the first and second film layers are reusable for adhesion.

Additional advantages and features of the invention will become apparent from the description which follows, and may be realized by means of the instrumentalities and combinations particular point out in the appended claims.

According to the present invention, the foregoing and other objects and advantages are attained by a double-sided reusable adhesive sheet comprising: a substrate; a first film layer attached to one surface of the substrate; and a second film layer attached to an opposed surface of the substrate, wherein a glass transition temperature of a high temperature curing process of the first and second film layers is 120˜240° C., so as to form the first and second film layers.

In the aforesaid double-sided reusable adhesive sheet, the surfaces of the first and second film layers are respectively provided with a plurality of micro-bubble structures for enhancing an adhering force thereof

In the aforesaid double-sided reusable adhesive sheet, a thickness of the first film layer is 0.05˜0.2 cm.

In the aforesaid double-sided reusable adhesive sheet, a thickness of the second film layer is 0.05˜0.2 cm.

In the aforesaid double-sided reusable adhesive sheet, the first and second film layers further comprise a release paper layer respectively.

In the aforesaid double-sided reusable adhesive sheet, a material of the substrate is selected from a group consisting of polyethylene terephthalate (PET), polyethylene (PE), polyester (Te talon), metal and wood.

In the aforesaid double-sided reusable adhesive sheet, a material of the first and second film layers is styrene resilient film layers (styrene-ethylene-butylenes-styrene, SEBS).

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 is a schematic view of a double-sided reusable adhesive sheet according to a preferred embodiment of the present invention.

FIG. 2 is a schematic view of a double-sided reusable adhesive sheet according to another preferred embodiment of the present invention.

FIG. 3 is a schematic view of a double-sided reusable adhesive sheet according to another preferred embodiment of the present invention.

### DETAILED DESCRIPTION OF THE PREFERRED EMBODIMENT

The following description is disclosed to enable any person skilled in the art to make and use the present invention. Preferred embodiments are provided in the following description only as examples and modifications will be apparent to those skilled in the art. The general principles defined in the following description would be applied to other embodiments, alternatives, modifications, equivalents, and applications without departing from the spirit and scope of the present invention.

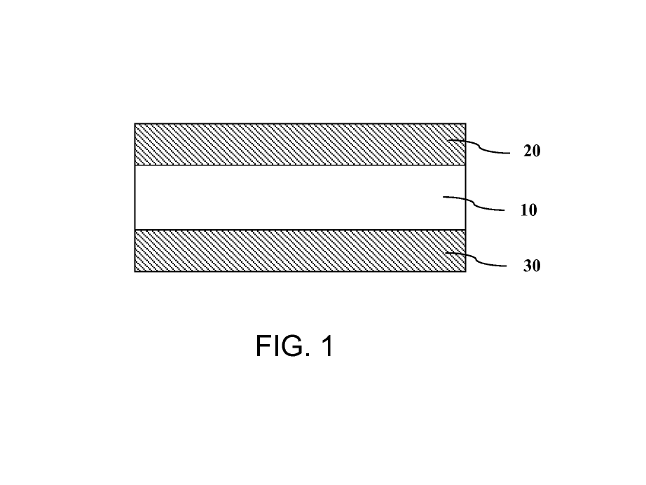

Referring to FIG. 1 of the drawings, FIG. 1 is an exploded view illustrating a double-sided reusable adhesive sheet according to a preferred embodiment of the present invention. The double-sided reusable adhesive sheet 1 of the present invention mainly consists of a substrate 10, a first film layer 20 and a second film layer 30. The substrate 10, which is made of polyethylene terephthalate (PET), has one surface which is adhered with the first film layer 10 and an opposed surface which is adhered with the second film layer 30. The first and second film layers 20 and 30 are made of styrene resilient film layers (styrene-ethylene-butylenes-styrene, SEBS). In addition, during a glue mixing process of the first and second film layers 20 and 30, a glass transition temperature of a high temperature curing process is 120˜240° C. At this temperature, the mixed glue form the film layers after the high temperature curing process, and each of the first and second film layers 20 and 30 may have a thickness of no more than 0.2 cm. The first and second film layers 20 and 30 prepared from the high temperature preparing process can be repeatedly used for adhesion, and there is no residual glue, so that the sheet is convenient to use. Furthermore, the thickness of each of the first and second film layers 20 and 30 can be, but are not limited to, 0.05-0.2 cm. The material of the substrate 10 can be, but is not limited to, polyethylene (PE), polyester (Te talon), metal, or wood.

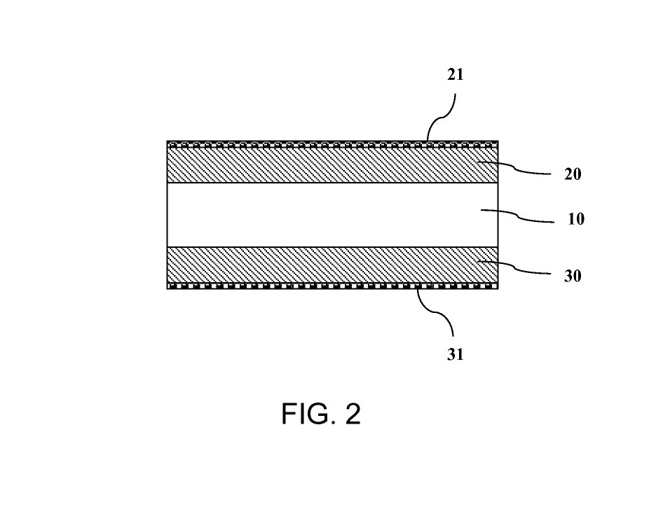

Referring to FIG. 2 of the drawings, FIG. 2 is an exploded view illustrating a modified structure of the double-sided reusable adhesive sheet of the above preferred embodiment. As shown in FIG. 2, the double-sided reusable adhesive sheet of this preferred embodiment mainly consists of a substrate 10, a first film layer 20 and a second film layer 30. The glass transition temperature of the high temperature curing process of the first and second film layers 20 and 30 is 120° C. A plurality of micro-bubble structures 21 and 31, which provides a function similar to a vacuum sucking disc, is respectively formed on surfaces of the first and second film layers 20 and 30. When the plurality of micro-bubble structures 21 and 31 is adhering with other surfaces, the surface tension of the double-sided reusable adhesive sheet 1 is enhanced, so that an enhanced adhering force and a film layer structure with a more stable performance are obtained. The material of the first and second film layers 20 and 30 is, but is not limited to, styrene resilient film layers (SEBS). The glass transition temperature of the high temperature curing process is, but is not limited to, 120˜240° C. The thickness of each of the first and second film layers 20 and 30 can be, but is not limited to, 0.05˜0.2 cm. The material of the substrate 10 can be, but is not limited to, polyethylene (PE), polyester (Te talon), metal, or wood.

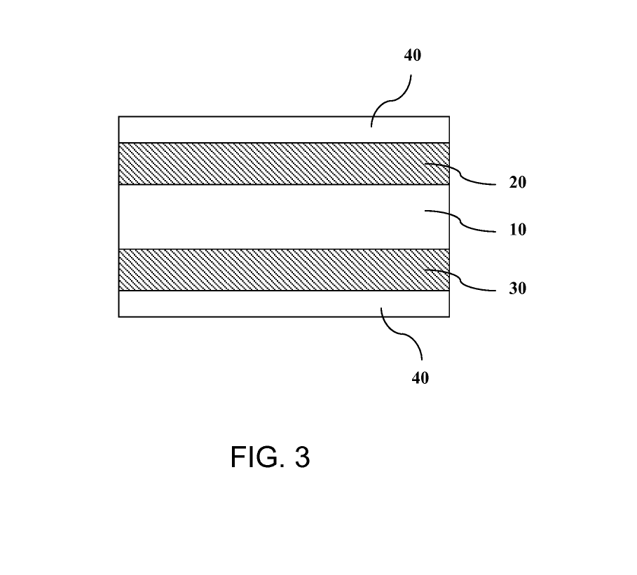

Referring to FIG. 3 of the drawings, FIG. 3 is an exploded view illustrating a double-sided reusable adhesive sheet according to another alternative mode of the above preferred embodiment illustrated in FIG. 1. As shown in the drawings, the first and second film layers 20 and 30 of the double-sided reusable adhesive sheet 1 are respectively provided with a release paper layer 40. When the above mentioned double-sided reusable adhesive sheet 1 is not in use, the release paper layers 40 protect the first and second film layers 20 and 30, respectively, from being contaminated by an external adhesive substance, so that the adhering force of each of the first and second film layers 20 and 30 is maintained. When reusable adhesive sheet 1 is in use, the release paper layers 40 are removed, so that the double-sided reusable adhesive sheet 1 can be used for adhesion. Similar to the double-sided reusable adhesive sheet of the above preferred embodiment, the material of the substrate 10 can be, but is not limited to, polyethylene (PE), polyester (Te talon), metal, or wood.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A double-sided reusable adhesive sheet, comprising:
a substrate;
a first film layer attached to one surface of said substrate; and
a second film layer attached to an opposed surface of said substrate, wherein a glass transition temperature of a high temperature curing process of said first and second film layers is 120˜240° C., so as to form said first and second film layers.

2. The double-sided reusable adhesive sheet, as recited in claim 1, wherein surfaces of said first and second film layers are respectively provided with a plurality of micro-bubble structures for enhancing an adhering force thereof.

3. The double-sided reusable adhesive sheet, as recited in claim 1, wherein a thickness of said first film layer is 0.05˜0.2 cm.

4. The double-sided reusable adhesive sheet, as recited in claim 1, wherein a thickness of said second film layer is 0.05˜0.2 cm.

5. The double-sided reusable adhesive sheet, as recited in claim 1, wherein said first and second film layers further comprise a release paper layer respectively.

6. The double-sided reusable adhesive sheet, as recited in claim 1, wherein a material of said substrate is selected from a group consisting of polyethylene terephthalate, polyethylene, polyester, metal and wood.

7. The double-sided reusable adhesive sheet, as recited in claim 1, wherein a material of said first and second film layers is styrene resilient film layers.
